(19) United States
(12) Patent Application Publication
(10) Pub. No.: US 2024/0355004 A1
(43) Pub. Date: Oct. 24, 2024

(54) VARIABLE RATE COMPRESSION OF POINT CLOUD GEOMETRY

(71) Applicants: SONY GROUP CORPORATION, TOKYO (JP); SONY CORPORATION OF AMERICA, NEW YORK, NY (US)

(72) Inventors: ALEXANDRE ZAGHETTO, SAN JOSE, CA (US); DANILLO GRAZIOSI, FLAGSTAFF, AZ (US); ALI TABATABAI, CUPERTINO, CA (US)

(21) Appl. No.: 18/303,056

(22) Filed: Apr. 19, 2023

(51) Int. Cl. G06T 9/00; G06N 3/0455; G06N 3/0985

(52) U.S. Cl. CPC G06T 9/002; G06N 3/0455; G06N 3/0985

(57) ABSTRACT

An electronic device and method for a variable rate compression of a point cloud geometry is provided. The electronic device stores a set of RD operation points and coding modes associated with the set of RD operation points. The electronic device receives a 3D point cloud geometry and partitions the 3D geometry into a set of blocks. After the partition, the electronic device selects a block and computes a set of loss values associated with one or more compression metrics. Such loss values correspond to a set of coding modes associated with at least a subset of the set of RD operation points. From the set of coding modes, the electronic device selects a coding mode for which a loss value of the set of loss values is below a loss threshold for that coding mode. Thereafter, the electronic device encodes the block based on the coding mode.

### CROSS-REFERENCE TO RELATED APPLICATIONS/INCORPORATION BY REFERENCE

None.

### FIELD

Various embodiments of the disclosure relate to three-dimensional (3D) point cloud compression (PCC). More specifically, various embodiments of the disclosure relate to a variable rate compression of point cloud geometry.

### BACKGROUND

Advancements in three-dimensional (3D) scanning have provided the ability to create 3D geometrical representations of 3D objects with high fidelity. 3D point clouds are one example of such 3D geometrical representations and have been adopted for different applications, such as free viewpoint display for sports or a live event relay broadcasting, geographic information systems, cultural heritage representations, or autonomous navigation of vehicles. Typically, point clouds include a large number of unstructured 3D points (e.g., each point having X, Y, and Z coordinates) along with associated attributes, for example, texture including colors or reflectance. When compressing a 3D point cloud, it is desirable that most of the attributes associated with the 3D point cloud are preserved to facilitate in efficient reconstruction of the point cloud from encoded point cloud data. Thus, it may be desirable to have an efficient point cloud compression (PCC) approach. For geometry compression, conventional PCC approaches may offer only a limited amount of operation points. When applied on a point cloud geometry, such approaches can lead to artifacts in reconstructed point cloud geometry.

Limitations and disadvantages of conventional and traditional approaches will become apparent to one of skill in the art, through comparison of described systems with some aspects of the present disclosure, as set forth in the remainder of the present application and with reference to the drawings.

### SUMMARY

An electronic device and method for a variable rate compression of a point cloud geometry is provided substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram that illustrates an exemplary environment for a variable rate compression of a point cloud geometry, in accordance with an embodiment of the disclosure.

FIG. 2 is a block diagram of an exemplary electronic device of FIG. 1, in accordance with an embodiment of the disclosure.

FIG. 3 is a block diagram of an exemplary encoder and an exemplary decoder for a variable rate compression of a point cloud geometry, in accordance with an embodiment of the disclosure.

FIG. 4 is a diagram that illustrates exemplary components of the circuitry of FIG. 2, in accordance with an embodiment of the disclosure.

FIG. 5 is a diagram that illustrates an exemplary processing pipeline for a variable rate compression of a point cloud geometry, in accordance with an embodiment of the disclosure.

FIG. 6 is a diagram that illustrates an exemplary search pattern for modes of RD operation points, in accordance with an embodiment of the disclosure.

FIG. 7 is a diagram that illustrates an exemplary comparison between lossy versus lossless reconstruction outputs for a point cloud geometry, in accordance with an embodiment of the disclosure.

FIG. 8 is a diagram that illustrates an exemplary 3D point cloud geometry and a selection of Region of Interest (RoI) in the point cloud geometry for point cloud compression, in accordance with an embodiment of the disclosure.

FIG. 9 is a flowchart that illustrates exemplary operations for a variable rate compression of a point cloud geometry, in accordance with an embodiment of the disclosure.

### DETAILED DESCRIPTION

The following described implementations may be found in the disclosed electronic device and method of a variable rate compression of a point cloud geometry. Exemplary aspects of the disclosure provide an electronic device that may include a memory configured to store a set of rate distortion (RD) operation points and one or more coding modes associated with each RD operation point of the set of RD operation points. The electronic device may further include circuitry that may be configured to receive a three-dimensional (3D) point cloud geometry pertaining to one or more objects in 3D space. The electronic device may be further configured to partition the 3D point cloud geometry into a set of blocks and select a first block from the set of blocks. For the selected first block, the electronic device may be further configured to compute a first set of loss values associated with one or more compression metrics. The set of loss values may correspond to a set of coding modes associated with at least a subset of the set of RD operation points. The electronic device may be further configured to select, from the set of coding modes, a coding mode for which a loss value of the first set of loss values is below a loss threshold for the coding mode. Thereafter, the electronic device may encode the selected first block based on the selected coding mode.

In conventional Point Cloud Compression (PCC) approaches, the trivial way is to compress a point cloud geometry by selecting a mode using a full-search algorithm that checks which mode yields the best rate-distortion (RD) performance. A possible implementation of adaptive block-based point cloud geometry compression is based on machine learning. Several models may be trained with each model tuned to specific learned local point cloud characteristics. RD control may be implemented via implicit and explicit quantization. In these conventional approaches, unpredictable local artifacts may be present in locally reconstructed geometry. Such artifacts may be derived from a strong non-linearity introduced by machine learning-based point cloud compression schemes. Additionally, these conventional approaches may not support a raw points coding mode or region of interest-based coding mode. In some of the existing approaches (e.g., Adaptive Deep Learning PCC (ADL-PCC)), given a specific RD operation point, a model (i.e., a coding mode) may return a minimum cost (e.g., rate-distortion, bitrate, or a combination of both). In present disclosure, it is considered that the minimum cost among all models for a given RD point may be too high (above a threshold). Thus, the electronic device of the present disclosure allows for the encoder to switch between different RD operation points to search for a model (i.e., a mode) that meets cost constraints. In a more general formulation, a bidirectional search across all modes in RD points may enable the encoder to meet any user defined constraints or quality requirements (e.g., less reconstruction artifacts). The present disclosure allows for use of a combination of different RD modes to encode different parts of the point cloud and improves the visual quality of reconstructed point clouds by locally imposing a maximum allowed cost threshold. The disclosure further presents a lossless mode to encode raw points that may be enabled if none of the available modes are able to meet a maximum cost criteria. Alternatively, the disclosure allows for a region of interest-based coding of different slices of the point cloud geometry.

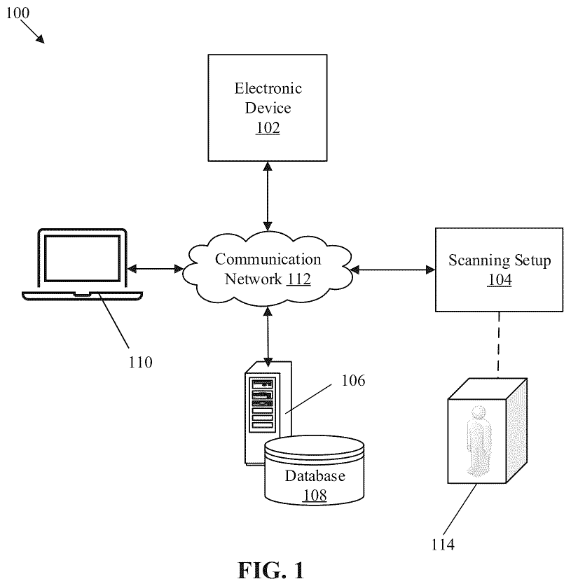

FIG. 1 is a block diagram that illustrates an exemplary environment for a variable rate compression of a point cloud geometry, in accordance with an embodiment of the disclosure. With reference to FIG. 1, there is shown a network environment 100. The network environment 100 may include an electronic device 102, a scanning setup 104, a server 106, a database 108, and a computing device 110. The scanning setup 104 may include one or more image sensors (not shown) and one or more depth sensors (not shown) associated with the one or more image sensors. The electronic device 102 may be communicatively coupled to the scanning setup 104, the server 106, and the computing device 110, via a communication network 112. There is further shown a three-dimensional (3D) point cloud geometry 114 of a 3D point cloud associated with at least one object (e.g., a person) in a 3D space.

The electronic device 102 may include suitable logic, circuitry, interfaces, and/or code that may be configured to encode and/or decode a 3D point cloud geometry (e.g., the 3D point cloud geometry 114). The 3D point cloud may include a set of data points in space. The points may represent a 3D shape of the object such that each point position corresponds to a set of Cartesian coordinates. As an example, each point may be represented as (x, y, z, r, g, b, α), where (x, y, z) represents 3D coordinates of a point on the object, (r, g, and b) represent red, green, and blue values of the point, and (α) may represent a transparency value of the point.

In some embodiments, the electronic device 102 may be configured to generate the 3D point cloud of an object or a plurality of objects (e.g., a 3D scene that includes objects in foreground and background). The electronic device 102 may acquire the 3D point cloud geometry 114 of the object (or the plurality of objects) from the 3D point cloud. Examples of the electronic device 102 may include, but are not limited to, a computing device, a video-conferencing system, an augmented reality (AR) device, a virtual reality (VR device), a mixed reality (MR) device, a game console, a smart wearable device, a mainframe machine, a server, a computer workstation, and/or a consumer electronic (CE) device.

The scanning setup 104 may include suitable logic, circuitry, interfaces, and/or code that may be configured to scan a 3D environment that includes the object to generate a raw 3D scan (also referred to as a raw 3D point cloud). In accordance with an embodiment, the scanning setup 104 may include a single image-capture device or a plurality of image-capture devices (arranged at multiple viewpoints) to capture a plurality of color images. In certain instances, additional depth sensors may be included in the scanning setup 104 to capture depth information of the object. The plurality of color images and the depth information of the object may be captured from different viewpoints. In such cases, the 3D point cloud may be generated based on the captured plurality of color images and the corresponding depth information of the object.

The scanning setup 104 may be configured to execute a 3D scan of the object in the 3D space and generate a dynamic 3D point cloud (i.e., a point cloud sequence) that may capture changes in different attributes and geometry of the 3D points at different time-steps. The scanning setup 104 may be configured to transmit the generated 3D point cloud, the plurality of color images, and/or the corresponding depth information to the electronic device 102 and/or the server via the communication network 112.

In accordance with an embodiment, the scanning setup 104 may include a plurality of sensors, such as a combination of a depth sensor, a color sensor (such as a red-green-blue (RGB) sensor), and/or a combination of an infrared (IR) projector and an IR sensor. For example, the depth sensor may capture information associated with the point cloud geometry (3D location of the points), and the RGB and IR sensor may capture information associated with point cloud attributes (color and temperature, for instance). In an embodiment, the IR projector and the IR sensor may be used to estimate depth information. The combination of the depth sensor, the RGB sensor, and the IR sensor may be used to capture a point cloud frame (single static point cloud) or a plurality of point cloud frames (3D video) with the associated geometry and attributes.

In accordance with an embodiment, the scanning setup 104 may include an active 3D scanner that relies on radiations or light to capture a 3D structure of an object in the 3D space. Also, the scanning setup 104 may include an image sensor that may capture color information associated with the object. For example, the active 3D scanner may be a time-of-flight (TOF)-based 3D laser scanner, a laser rangefinder, a TOF camera, a hand-held laser scanner, a structured light 3D scanner, a modulated light 3D scanner, a CT scanner that outputs point cloud data, an aerial Light Detection and Ranging (LiDAR) scanner, a 3D LiDAR, a 3D motion sensor, and the like.

In FIG. 1, the scanning setup 104 is shown as separate from the electronic device 102. However, in some embodiments, the scanning setup 104 may be integrated into the electronic device 102. In an alternate embodiment, the entire functionality of the scanning setup 104 may be incorporated in the electronic device 102, without a departure from the scope of the present disclosure. Examples of the scanning setup 104 may include, but are not limited to, a depth sensor, an RGB sensor, an IR sensor, an image sensor, a light cage with cameras, and/or a motion-detector device.

The server 106 may include suitable logic, circuitry, interfaces, and/or code that may be configured to execute operations, such as data/file storage, 3D rendering, or 3D reconstruction operations (such as a photogrammetric reconstruction operation) to generate a 3D point cloud of the object. By way of example, and not limitation, the 3D reconstruction operations may be performed by using a photogrammetry-based method (such as structure from motion (SfM)), a method which requires stereoscopic images, or a method which requires monocular cues (such as shape from shading (SfS), photometric stereo, or shape from texture (SfT)). Details of such methods have been omitted from the disclosure for the sake of brevity. Examples of the server 106 may include, but are not limited to, an application server, a cloud server, a web server, a database server, a file server, a gaming server, a mainframe server, or a combination thereof.

The database 108 may include suitable logic, interfaces, and/or code that may be configured to store a point cloud geometry. The database 108 may be derived from data off a relational or non-relational database or a set of comma-separated values (csv) files in conventional or big-data storage. The database 108 may be stored or cached on a device, such as the server 106. In some embodiments, the database 108 may be hosted on a plurality of servers stored at same or different locations. The operations of the database 108 may be executed using hardware including a processor, a microprocessor (e.g., to perform or control performance of one or more operations), a field-programmable gate array (FPGA), or an application-specific integrated circuit (ASIC). In some other instances, the database 108 may be implemented using software.

The computing device 110 may include suitable logic, circuitry, interfaces, and/or code that may be configured to communicate with the electronic device 102 and/or the server, via the communication network 112. In accordance with an embodiment, the computing device 110 may include a memory configured to store a set of rate distortion (RD) operation points and one or more coding modes associated with each RD operation point of the set of RD operation points. The computing device 110 may be configured to receive an encoded 3D point cloud geometry (e.g., as a part of multimedia content) from the electronic device 102. The computing device 110 may be configured to decode the encoded 3D point cloud geometry to render a 3D model of the object. Examples of the computing device 110 may include, but are not limited to a desktop, a personal computer, a laptop, a computer workstation, a tablet computing device, a smartphone, a cellular phone, a mobile phone, a consumer electronic (CE) device having a display, a television (TV), a wearable display, a head mounted display, a digital signage, a digital mirror (or a smart mirror) with capability to store or render the multimedia content.

In accordance with another embodiment, the computing device 110 may be configured to receive an input from a user to determine a portion of the 3D point cloud geometry as a region of Interest (ROI). In conjunction with an object detection operation or a semantic segmentation operation, the user input may be used to determine the ROI. i.e., a part of the 3D point cloud as the ROI.

In operation, the electronic device 102 may receive a 3D point cloud geometry (such as the 3D point cloud geometry 114) associated with at least one object in 3D space. For example, 3D point cloud data may be obtained from a 3D point cloud (or a 3D scan) that includes geometry and various attributes. The 3D point cloud may be a static point cloud or may be a frame of a dynamic point cloud (i.e., a point cloud sequence). In general, a 3D point cloud is a representation of geometrical information (e.g., the 3D coordinates of points) and attribute information of the object in the 3D space. The attribute information may include, for example, color information, reflectance information, opacity information, normal vector information, material identifier information, or texture information associated with the object in the 3D space. The texture information may represent a spatial arrangement of colors or intensities in the plurality of color images of the object. The reflectance information may represent information associated with an empirical model (e.g., a Phong shading model or a Gouraud Shading model) of a local illumination of points of the 3D point cloud. The empirical model of the local illumination may correspond to a reflectance (rough or shiny surface portions) on a surface of the object. The opacity information may represent the degree of transparency of a point. The normal vector information may represent a direction perpendicular to the plane tangent at a point of the point cloud.

After the reception, the electronic device 102 may generate a plurality of voxels from the 3D point cloud geometry 114. The generation of the voxels may be referred to as a voxelization of the 3D point cloud geometry 114. Conventional techniques for voxelization of a 3D point cloud may be known to one ordinarily skilled in the art. Thus, the details of the voxelization are omitted from the disclosure for the sake of brevity. In accordance with an embodiment, the 3D point cloud geometry 114 may be received as a voxelized point cloud.

If the 3D point cloud geometry 114 includes a large number of data points (of the order of 10⁴ or more, for example), then the transmission or reception of such data points can consume a high network bandwidth. Similarly, the data points, in an uncompressed state, can consume a large amount of storage space. In some network-based streaming applications, a 3D point cloud or a 3D point cloud sequence may have to streamed in near real time (e.g., free viewpoint video) to one or more media devices for rendering operations. Before the rendering operations can be performed, the 3D point cloud or the 3D point cloud sequence must be encoded on a source device (e.g., the electronic device 102) to achieve a size (in bytes, for example) that is less than uncompressed size of the 3D point cloud or the 3D point cloud sequence. The size may help to render a smoother streaming experience while the rendering operations are performed. Thus, the 3D point cloud geometry 114 may be encoded (i.e., compressed) to minimize a network bandwidth usage and a storage space usage for transmission/reception of the 3D point cloud geometry 114. The encoding process of the 3D point cloud geometry 114 is described herein.

The electronic device 102 may partition the 3D point cloud geometry 114 into a set of blocks and may select a first block (e.g., B₀) from the set of blocks. The selection of blocks may be performed iteratively. For each selection, a linear search may be performed from RD₀ to RD_{N}, in which coding modes for each RDᵢ may be selected (i.e., from a mode⁰ to a mode^{M}) in a linear manner to compute a loss value. For the selected first block, the search may result in a pair of mode^{j}, RDᵢ for which the loss value may be below a loss threshold for the mode^{j}. The loss threshold for a given coding mode may be a static value or may be dynamically adjusted based on a human input or a target rate-distortion or quality. An example of twenty-five (25) coding modes for a set of five RD operation points is provided in Table 1, as follows:

TABLE 1
Exemplary compression metric

| | Mode⁰ | Mode¹ | Mode² | Mode³ | Mode⁴ |
|---|---|---|---|---|---|
| RD₀ | Model₀⁰ | Model₀¹ | Model₀² | Model₀³ | Model₀⁴ |
| RD₁ | Model₁⁰ | Model₁¹ | Model₁² | Model₁³ | Model₁⁴ |
| RD₂ | Model₂⁰ | Model₂¹ | Model₂² | Model₂³ | Model₂⁴ |
| RD₃ | Model₃⁰ | Model₃¹ | Model₃² | Model₃³ | Model₃⁴ |
| RD₄ | Model₄⁰ | Model₄¹ | Model₄² | Model₄³ | Model₄⁴ |

As part of the linear search, the electronic device 102 may compute a first set of loss values for the selected first block. The computed first set of loss values may be associated with one or more compression metrics. For example, the metrics may include a rate metric (e.g., a rate distortion) or a mean square error (MSE) metric. The set of loss values may correspond to a set of coding modes. Such modes may be associated with at least a subset of the set of RD operation points. For example, Table 1 discloses that for every RD operation point (i.e., RD₀ to RD₄), there are multiple modes (i.e., Mode₀ to Mode₄). Each coding mode may correspond to a deep neural network, (referred to as Modelᵢ^{j}, where j is index of mode and i is index of RD points). The deep neural network may be trained to encode the selected first block of the 3D point cloud geometry 114 to generate an encoded first block.

For any block of the point cloud geometry 114, the linear search may end at any arbitrary coding mode of any rate distortion point. Thus, the set of coding modes (for which the set of loss values is computed) may only correspond to a subset of the set of RD operation points. In worst case (i.e., with a worst-case time complexity), the linear search may cover all coding modes and all RD points. In such a case, the subset may include all RD operation points in the set of RD operation points.

From the set of coding modes, the electronic device 102 may select a coding mode for which a loss value of the first set of loss values is below a loss threshold. The loss threshold may be specific to the coding mode or may be same for all coding modes of a particular RD operation point. Thereafter, the electronic device 102 may encode the selected first block based on the selected coding mode. Similarly, the electronic device 102 may iteratively select modes for all remaining blocks of the 3D point cloud geometry 114 and may encode the remaining blocks of the 3D point cloud geometry 114. Encoded block data of all blocks of the 3D point cloud geometry 114 may be combined to generate an encoded 3D point cloud geometry.

In an embodiment, the electronic device 102 may generate supplemental information associated with the encoded 3D point cloud geometry. Examples of the supplemental information may include, but are not limited to, coding tables, mode selections, index values for geometrical information, and quantization parameters. The electronic device 102 may transmit the encoded 3D point cloud geometry to another electronic device that includes a decoder for a reconstruction of the 3D point cloud geometry. The supplemental information may be transmitted along with the encoded 3D point cloud geometry.

In an embodiment, the electronic device 102 may be configured to acquire a calibration point cloud from the computing device 110, the database 108, and/or the server 106. For a block of the calibration point cloud, the electronic device 102 may compute a first quartile of loss value corresponding each mode of an RD operation point of the set of RD operation points. The electronic device 102 may set the first quartile of loss value that corresponds to the coding mode as the loss threshold.

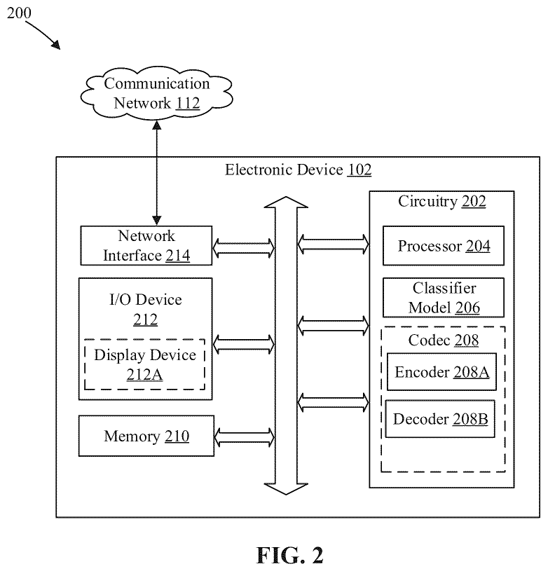

FIG. 2 is a block diagram that illustrates the exemplary electronic device of FIG. 1, in accordance with an embodiment of the disclosure. FIG. 2 is explained in conjunction with elements from FIG. 1. With reference to FIG. 2, there is shown a block diagram 200 of the electronic device 102. The electronic device 102 may include circuitry 202. The circuitry may include a processor 204, a classifier model 206, and a codec 208. In some embodiments, the codec 208 may also include an encoder 208A. In some embodiments, the codec may include a decoder 208B. The electronic device 102 may further include a memory 210, an input/output (I/O) device 212, and a network interface 214. The I/O device 212 may include a display device 212A which may be utilized to render multimedia content, such as a 3D point cloud or a 3D graphic model rendered from the 3D point cloud. The circuitry 202 may be communicatively coupled to the memory 210, the I/O device 212, and the network interface 214. The circuitry 202 may be configured to communicate with the server 106, the scanning setup 104, and the computing device 110 by use of the network interface 214.

The processor 204 may comprise suitable logic, circuitry, and/or interfaces that may be configured to execute instructions associated with the encoding of the 3D point cloud of an object. Also, the processor 204 may be configured to execute instructions associated with generation of the 3D point cloud of the object in the 3D space and/or reception of the plurality of color images and the corresponding depth information. The processor 204 may be further configured to execute various operations related to transmission and/or reception of the 3D point cloud (as the multimedia content) to and/or from the computing device 110. Examples of the processor 204 may be a Graphical Processing Unit (GPU), a Central Processing Unit (CPU), a Tensor Processing Unit (TPU), a Reduced Instruction Set Computing (RISC) processor, an Application-Specific Integrated Circuit (ASIC) processor, a Complex Instruction Set Computing (CISC) processor, a co-processor, other processors, and/or a combination thereof. In accordance with an embodiment, the processor 204 may be configured to facilitate the encoder 208A to encode the 3D point cloud and the decoder 208B to decode the encoded 3D point cloud and other functions of the electronic device 102.

The encoder 208A may include suitable logic, circuitry, and/or interfaces that may be configured to encode a 3D point cloud geometry that corresponds to an object in the 3D space. In an embodiment, the encoder 208A may encode the 3D point cloud by encoding each 3D block associated with the 3D point cloud geometry. In certain embodiments, the encoder 208A may be configured to manage storage of the encoded 3D point cloud geometry in the memory 210 and/or transfer of the encoded 3D point cloud geometry to other media devices (e.g., a portable media player), via the communication network 112.

In some embodiments, the encoder 208A may be implemented as a Deep Neural Network (in the form of computer-executable code) on a GPU, a CPU, a TPU, a RISC processor, an ASIC processor, a CISC processor, a co-processor, other processors, and/or a combination thereof. In some other embodiments, the encoder 208A may be implemented as a Deep Neural Network on a specialized hardware interfaced with other computational circuitries of the electronic device 102. In such an implementation, the encoder 208A may be associated with a specific form factor on a specific computational circuitry. Examples of the specific computational circuitry may include, but are not limited to, a field programmable gate array (FPGA), programmable logic devices (PLDs), an ASIC, a programmable ASIC (PL-ASIC), application specific integrated parts (ASSPs), and a System-on-Chip (SOC) based on standard microprocessors (MPUs) or digital signal processors (DSPs). In accordance with an embodiment, the encoder 208A may be also interfaced with a GPU to parallelize operations of the encoder 208A. In accordance with another embodiment, the encoder 208A may be implemented as a combination of programmable instructions stored in the memory 210 and logical units (or programmable logic units) on a hardware circuitry of the electronic device 102.

The decoder 208B may include suitable logic, circuitry, and/or interfaces that may be configured to decode encoded information that may represent the geometrical information of the object. The encoded information may also include the supplemental information, for example, coding tables, weight information, mode information, index values for the geometrical information and quantization parameters, to assist the decoder 208B. As an example, the encoded information may include the encoded 3D point cloud geometry. The decoder 208B may be configured to reconstruct the 3D point cloud geometry by decoding the encoded 3D point cloud geometry. In accordance with an embodiment, the decoder 208B may be present on computing device 110. According to an embodiment, the codec 208 may be integrated as a part of an integrated circuit such as a chip, system on chip (SOC), and the like,

The memory 210 may include suitable logic, circuitry, and/or interfaces that may be configured to store instructions executable by the circuitry 202. The memory 210 may be configured to store operating systems and associated applications. The memory 210 may be further configured to store the 3D point cloud (including the 3D point cloud geometry 114) corresponding to the object. In accordance with an embodiment, the memory 210 may be configured to store information related to the plurality of modes and the table that maps the plurality of modes with classes and operational conditions. In accordance with another embodiment, the memory 210 may be configured to store a set of rate distortion (RD) operation points and one or more coding modes associated with each RD operation point of the set of RD operation points. Examples of implementation of the memory 210 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The I/O device 212 may include suitable logic, circuitry, interfaces, and/or code that may be configured to receive a user input. The I/O device 212 may be further configured to provide an output in response to the user input. The I/O device 212 may include various input and output devices, which may be configured to communicate with the circuitry 202. Examples of the input devices may include, but are not limited to, a touch screen, a keyboard, a mouse, a joystick, and/or a microphone. Examples of the output devices may include, but are not limited to, the display device 212A and/or a speaker.

The display device 212A may include suitable logic, circuitry, interfaces, and/or code that may be configured to render the 3D point cloud onto a display screen of the display device 212A. In accordance with an embodiment, the display device 212A may be touch enabled screen to receive the user input. The display device 212A may be realized through several known technologies such as, but not limited to, a Liquid Crystal Display (LCD) display, a Light Emitting Diode (LED) display, a plasma display, and/or an Organic LED (OLED) display technology, and/or other display technologies. In accordance with an embodiment, the display device 212A may refer to a display screen of smart-glass device, a 3D display, a see-through display, a projection-based display, an electro-chromic display, and/or a transparent display.

The network interface 214 may include suitable logic, circuitry, interfaces, and/or code that may be configured to establish a communication between the electronic device 102, the server 106, the scanning setup 104, and the computing device 110, via the communication network 112. The network interface 214 may be implemented by use of various known technologies to support wired or wireless communication of the electronic device 102 with the communication network 112. The network interface 214 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, and/or a local buffer.

The network interface 214 may communicate via wireless communication with networks, such as the Internet, an Intranet and/or a wireless network, such as a cellular telephone network, a wireless local area network (LAN) and/or a metropolitan area network (MAN). The wireless communication may use any of a plurality of communication standards, protocols and technologies, such as Global System for Mobile Communications (GSM), Enhanced Data GSM Environment (EDGE), wideband code division multiple access (W-CDMA), Long Term Evolution (LTE), 5^{th} Generation (5G) New Radio (NR), code division multiple access (CDMA), time division multiple access (TDMA), Bluetooth, Wireless Fidelity (Wi-Fi) (such as IEEE 1002.11a, IEEE 1002.11b, IEEE 1002.11g and/or IEEE 1002.11n), voice over Internet Protocol (VoIP), light fidelity (Li-Fi), Wi-MAX, a protocol for email, instant messaging, and/or Short Message Service (SMS).

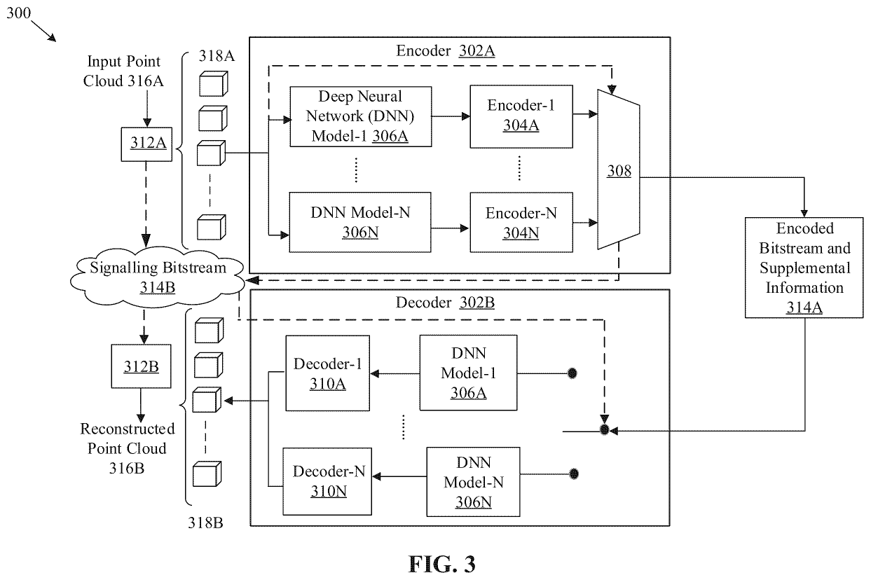

FIG. 3 is a block diagram of an exemplary encoder and an exemplary decoder for a variable rate compression of a point cloud geometry, in accordance with an embodiment of the disclosure. FIG. 3 is explained in conjunction with elements from FIG. 1 and FIG. 2. With reference to FIG. 3, there is shown a block diagram 300 that includes an encoder 302A and a decoder 302B. The encoder 302A may be an exemplary implementation of the encoder 208A of FIG. 2 and the decoder 302B may be an exemplary implementation of the decoder 208B of FIG. 2.

In an embodiment, the encoder 302A and the decoder 302B may be implemented on a separate electronic device. In another embodiment, both the encoder 302A and the decoder 302B may be implemented on the electronic device 102. The decoder 302B may be also implemented on the computing device 110.

The encoder 302A may include a set of encoders, such as, a first encoder (e.g., an encoder-1 304A), . . . and an Nth encoder (e.g., an encoder-N 304N). Each of the set of encoders of the encoder 302A may include an associated classifier model such as neural network model. For example, the encoder-1 304A may be operatively coupled to a first deep neural network (DNN) model, such as a DNN model-1 306A. Further, the encoder-N 304N may be operatively coupled to Nth DNN model, such as a DNN model-N 306N. The encoder 302A may further include a mode selector 308, which may be communicatively coupled to each of the encoder-1 304A, . . . and the encoder-N 304N.

Each deep neural network model (e.g., the DNN model-1 306A) may be a neural network model including a computational network or a system of artificial neurons, arranged in a plurality of layers, as nodes. The plurality of layers of the neural network model may include an input layer, one or more hidden layers, and an output layer. Each layer of the plurality of layers may include one or more nodes (or artificial neurons, represented by circles, for example). Outputs of all nodes in the input layer may be coupled to at least one node of hidden layer(s). Similarly, inputs of each hidden layer may be coupled to outputs of at least one node in other layers of the neural network model. Outputs of each hidden layer may be coupled to inputs of at least one node in other layers of the neural network model. Node(s) in the final layer may receive inputs from at least one hidden layer to output a result. The number of layers and the number of nodes in each layer may be determined from hyper-parameters of the neural network model. Such hyper-parameters may be set before or after training the neural network model on a training dataset.

Each node of the neural network model may correspond to a mathematical function (e.g., a sigmoid function or a rectified linear unit) with a set of parameters, tunable during training of the network. The set of parameters may include, for example, a weight parameter, a regularization parameter, and the like. Each node may use the mathematical function to compute an output based on one or more inputs from nodes in other layer(s) (e.g., previous layer(s)) of the neural network model. All or some of the nodes of the neural network model may correspond to same or a same mathematical function.

In training of the neural network model, one or more parameters of each node of the neural network may be updated based on whether an output of the final layer for a given input (from the training dataset) matches a correct result based on a loss function for the neural network model. The above process may be repeated for same or a different input until a minima of loss function may be achieved, and a training error may be minimized. Several methods for training are known in art, for example, gradient descent, stochastic gradient descent, batch gradient descent, gradient boost, meta-heuristics, and the like.

The neural network model may include electronic data, which may be implemented as, for example, a software component of an application executable on an electronic device (for example, the electronic device 102). The neural network model may rely on libraries, external scripts, or other logic/instructions for execution by a processing device, such as the circuitry 202. The neural network model may include code and routines configured to enable a computing device, such as the circuitry 202 to perform one or more operations to encode or decode a 3D block associated with a 3D point cloud geometry. Additionally, or alternatively, the classifier model such as neural network model may be implemented using hardware including a processor, a microprocessor (e.g., to perform or control performance of one or more operations), a field-programmable gate array (FPGA), or an application-specific integrated circuit (ASIC). Alternatively, in some embodiments, the neural network model may be implemented using a combination of hardware and software.

The decoder 302B include a set of decoders, such as, a first decoder (e.g., a decoder-1 310A), . . . and an Nth decoder (e.g., a decoder-N 310N). Each of the set of decoders may include an associated neural network model. For example, the decoder-1 310A may include a first DNN model, such as the DNN model-1 306A. Further, the decoder-N 310N may include an Nth DNN model, such as the DNN model-N 306N. In FIG. 3, there is shown a block partitioner 312A associated with the encoder 302A and a binarizer and merger 312B associated with the decoder 302B. Also shown are encoded bitstream and supplemental information 314A, a signaling bitstream 314B, an input point cloud 316A, a reconstructed point cloud 316N, and a set of 3D blocks 318.

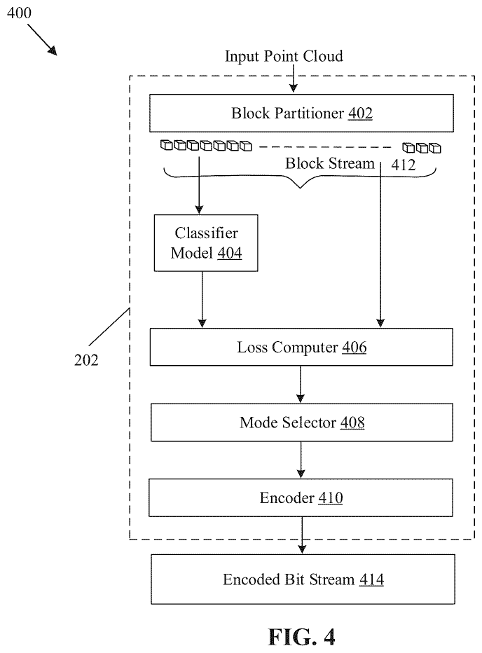

FIG. 4 is a diagram that illustrates exemplary components of the circuitry of FIG. 2, in accordance with an embodiment of the disclosure. FIG. 4 is explained in conjunction with elements from FIG. 1, FIG. 2, and FIG. 3. With reference to FIG. 4, there are shown various components of circuitry 202 for a variable rate compression of a point cloud geometry. The components 400 of the circuitry 202 may include a block partitioner 402, a classifier model 404, a loss computer 406, a mode selector 408, and an encoder 410.

The circuitry 202 may be configured to acquire, as an input point cloud, a 3D point cloud of one or more objects (such as a person) in a 3D space. The 3D point cloud may be a representation of geometrical information and attribute information of the one or more objects in 3D space. The geometrical information may be indicative of 3D coordinates (such as XYZ coordinates) of individual feature points of the 3D point cloud. Without the attribute information, the 3D point cloud may be represented as a 3D point cloud geometry (e.g., the 3D point cloud geometry 114) associated with the one or more objects. The attribute information may include, for example, color information, reflectance information, opacity information, normal vector information, material identifier information and texture information of the one or more objects. In accordance with an embodiment, the 3D point cloud may be received from the scanning setup 104 via the communication network 112 or may be directly acquired from an in-built scanner that may have same functionalities as that of the scanning setup 104.

Each feature point in the 3D point cloud may be represented as (x, y, z, Y, Cb, Cr, α, a₁, . . . aₙ), where (x, y, z) may be 3D coordinates that may represent the geometrical information and (Y, Cb, Cr) may be luma, chroma-blue difference, and chroma-red difference components (in YCbCr or YUV color space) of the feature point. α may be a transparency value of the feature point, and a₁ to aₙ represent one or multi-dimensional attributes like material identifier and normal vector. Collectively, Y, Cb, Cr, α and a₁ to aₙ may represent the attribute information of each feature point of the 3D point cloud.

The block partitioner 402 may receive the input point cloud and may partition the input point cloud into a set of blocks to generate a block stream 412. The block partitioner may perform a voxelization operation on the 3D point cloud. In the voxelization operation, the processor 204 may be configured to generate a plurality of voxels from the 3D point cloud. Each generated voxel may represent a volumetric element of one or more objects in a 3D space. The volumetric element may be indicative of attribute information and geometrical information corresponding to a group of feature points of the 3D point cloud.

The 3D space corresponding to the 3D point cloud may be considered as a cube that may be recursively partitioned into a plurality of sub-cubes (such as octants). The size of each sub-cube may be based on a density of feature points in the 3D point cloud. The plurality of feature points of the 3D point cloud may occupy different sub-cubes. Each sub-cube may correspond to a voxel and may contain a set of feature points of the 3D point cloud, within a specific volume of the corresponding sub-cube. The processor 204 may be configured to compute an average of the attribute information associated with set of feature points of the corresponding voxel. Also, the processor 204 may be configured to compute center coordinates for each voxel of the plurality of voxels based on the geometrical information associated with the corresponding set of feature points within the corresponding voxel. Each voxel of the generated plurality of voxels may be represented by the center coordinates and the average of the attribute information associated with the corresponding set of feature points.

In accordance with an embodiment, the process of voxelization of the 3D point cloud may be done using conventional techniques that may be known to one ordinarily skilled in the art. Thus, further details of such conventional techniques are omitted from the disclosure for the sake of brevity. The plurality of voxels may represent geometrical information and the attribute information of the one or more objects in the 3D space. Also, the plurality of voxels may include occupied voxels and unoccupied voxels. The unoccupied voxels may not represent the geometrical information and the attribute information of the one or more objects in the 3D space. Only the occupied voxels may represent the geometrical information and the attribute information (such as color information) of the one or more objects. In accordance with an embodiment, the processor 204 may be configured to identify the occupied voxels from the plurality of voxels.

The block partitioner 402 may be configured to partition the plurality of voxels of the 3D point cloud geometry 114 into a set of blocks (for example, the block stream 412). By way of example, and not limitation, the processor 204 may partition the 3D point cloud geometry 114 into blocks, each of which may be of a pre-determined size, such as 64×64×64. In an embodiment, the 3D point cloud geometry 114 may be partitioned into blocks of same size. In another embodiment, the 3D point cloud geometry 114 may be partitioned into blocks of different sizes. For example, the plurality of voxels may include a first set of voxels that may have a dense occupancy and a second set of voxels that may be sparse occupancy. While a portion of the 3D point cloud geometry 114 that includes densely occupied voxels may be partitioned into a first set of blocks of size 32×32×32, another portion of the 3D point cloud geometry 114 that includes sparsely occupied voxels may be partitioned into a second set of blocks of size 64×64×64. In accordance with an embodiment, the processor 204 may select a block size to partition different portions of the 3D point cloud geometry 114 based on a tradeoff between a computation cost associated with the partitioning operation and a density of occupancy of the partitioned blocks.

The classifier model 404 may receive the plurality of voxels as an input. The classifier model may be a neural network model such as a DNN model. As a neural network model, the classifier model 404 may be a computational network or a system of artificial neurons that may be arranged in a plurality of layers. The plurality of layers of the neural network model may include an input layer, one or more hidden layers, and an output layer. Each layer of the plurality of layers may include one or more nodes (or artificial neurons, represented by circles, for example). Outputs of all nodes in the input layer may be coupled to at least one node of hidden layer(s). Similarly, inputs of each hidden layer may be coupled to outputs of at least one node in other layers of the neural network model. Outputs of each hidden layer may be coupled to inputs of at least one node in other layers of the neural network model. Node(s) in the final layer may receive inputs from at least one hidden layer to output a result. The number of layers and the number of nodes in each layer may be determined from hyper-parameters of the neural network model. Such hyper-parameters may be set before or after training the neural network model on a training dataset.

Each node of the neural network model may correspond to a mathematical function (e.g., a sigmoid function or a rectified linear unit) with a set of parameters that may be tunable during training of the network. The set of parameters may include, for example, a weight parameter, a regularization parameter, and the like. Each node may use the mathematical function to compute an output based on one or more inputs from nodes in other layer(s) (e.g., previous layer(s)) of the neural network model. All or some of the nodes of the neural network model may correspond to same or a different mathematical function.

In training of the neural network model, one or more parameters of each node of the neural network may be updated based on whether an output of the final layer for a given input (from the training dataset) matches a correct result based on a loss function for the neural network model. The above process may be repeated for same or a different input until a minima of loss function is achieved, and a training error is minimized. Several methods for training are known in art, for example, gradient descent, stochastic gradient descent, batch gradient descent, gradient boost, meta-heuristics, and the like.

The classifier model 404 may include electronic data, which may be implemented as, for example, a software component of an application executable on an electronic device (for example, the electronic device 102). The classifier model 404 may rely on libraries, external scripts, or other logic/instructions for execution by a processing device, such as the circuitry 202. The classifier model 404 may include code and data that may enable a computing device, such as the circuitry 202 to perform one or more operations to encode or decode a block associated with a 3D point cloud geometry. The classifier model 404 may be implemented using hardware including a processor, a microprocessor (e.g., to perform or control performance of one or more operations), a field-programmable gate array (FPGA), or an application-specific integrated circuit (ASIC). Alternatively, in some embodiments, the classifier model 404 may be implemented using a combination of hardware and software.

The loss computer 406 may receive an input from the classifier model 404. The loss computer 406 may be configured to compute loss values for the blocks of the block stream 412. A block or a set of blocks may be selected by the processor 204 from the block stream 412. For the selected block or the set of blocks, a set of loss values associated with one or more compression metrics may be computed. The set of loss values may correspond to a set of coding modes associated with at least a subset of the set of RD operation points. The first set of loss values may be computed based on an output of the classifier model 404 for the input. The set of loss values may include one or more loss values that are computed for one or more coding modes corresponding to a first RD operation point of the set of RD operation points. The loss values may be computed for each block of the block stream 412.

The mode selector 408 may receive an input from the loss computer 406. Based on the input from the loss computer 406, a mode selection operation may be executed. In the mode selection operation, the processor 204 may be configured to determine mode for a block of the set of blocks. In an alternate embodiment, the mode selection operation may be executed by the encoder 208A. Further, the processor 204 may be configured to select one or more coding modes (for example, selected one or more coding modes) for the block from the plurality of coding modes, based on comparison of the computed loss value for the block or the set of blocks, and the loss threshold for the coding mode. Herein, each mode of the plurality of modes may correspond to a function that may be used to encode a block.

In an embodiment, the one or more modes may be selected based on a lookup from a table or metric that may map modes to classes and operational conditions. In another embodiment, the one or more modes may be selected based on modes used by blocks adjacent to the current block in a spatial arrangement of the set of blocks in the 3D point cloud geometry 114.

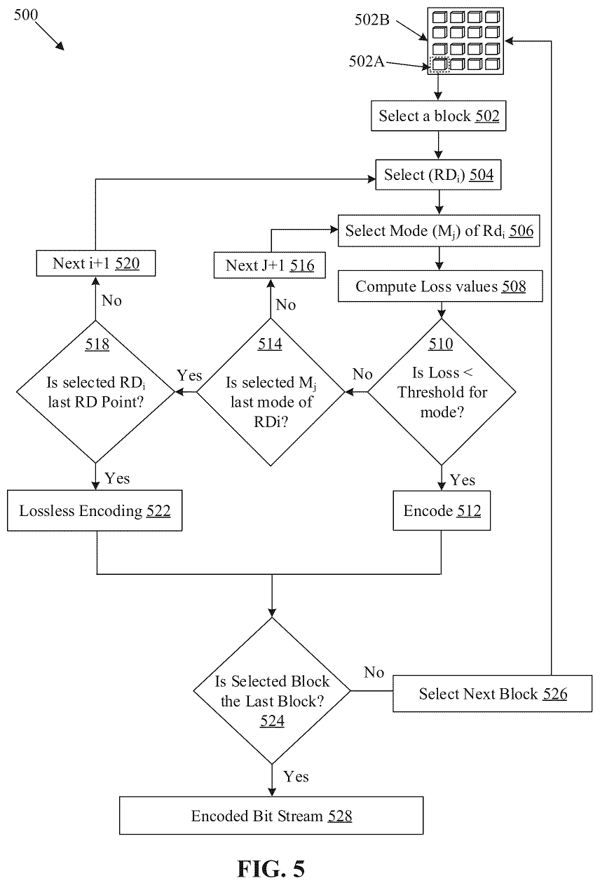

In case the one or more modes include more than one mode, the processor 204 may determine a rate-distortion cost associated with each of the selected one or more modes and may compare the determined rate-distortion costs with one another. Based on the comparison of the determined rate-distortion costs, the processor 204 may select a mode with the least rate-distortion cost as an optimum mode from the selected one or more modes to encode the current 3D block. In another scenario, in case the one or more modes includes a single mode, the rate-distortion cost of the mode may not be determined. Instead, the single mode may itself be the optimum mode to encode the current block. The determination of the mode and the selection of the one or more modes are described further in detail in FIG. 5.

The encoder 410 may be configured to encode the block based on the selected one or more modes. For example, the encoder 410 may encode the block to obtain an encoded block 414 based on the selected one or more modes.

FIG. 5 is a diagram that illustrates an exemplary processing pipeline for variable rate compression of a point cloud geometry, in accordance with an embodiment of the disclosure. FIG. 5 is explained in conjunction with elements from FIG. 1, FIG. 2, FIG. 3, and FIG. 4. With reference to FIG. 5, there is shown a processing pipeline 500. In the processing pipeline 500, there is shown a sequence of operations from 502 to 526. The sequence of operations may be executed by any computing device, such as by the circuitry 202 of the electronic device 102.

At 502, a first block 502A (i.e., a 3D block) may be selected from a set of blocks 502B (i.e., 3D blocks) of the 3D point cloud geometry. The circuitry 202 may be configured to partition the 3D point cloud geometry into the set of blocks 502B. The selection may be part of an iterative selection process to search for an optimal coding mode and an optimal RD operation point for each block. The search may be a bidirectional search across all modes corresponding to a set of RD operation points. During search, the circuitry 202 (e.g., block encoder) may be allowed to switch between different RDᵢ operation points searching for a mode that meets a set cost constraint (i.e., a loss threshold).

At 504, a rate-distortion (RDᵢ) operation point selection may be performed. In RDᵢ point selection, an RDᵢ operating point may be selected from a set of RD operation points (for example, from RD₀ to RD₄, as described in Table 1 of FIG. 1). For example, RD₀ (for i=0) may be selected from RD₀ to RD₄, as described in Table 1. Each RD operation point may correspond to a specific rate-distortion between an original and a reconstructed point cloud block. The rate-distortion may be based on a point-to-point distance or a plane-to-plane distance (or any other objective or subjective distortion metric) between corresponding points in an original point cloud block and a reconstructed point cloud block, and the estimated number of bits needed to encode the corresponding block. Each RD operation point of the set of RD operation points may be associated with one or more loss thresholds corresponding to one or more coding modes for the RD operation point.

At 506, a mode selection operation may be executed. In mode selection operation, the circuitry 202 may be configured to select a coding mode (such as M₀) from one or more coding modes (such as M₀ to M₄ of Table 1) associated with the selected RD operation point (RD₀). Such coding modes may correspond to deep neural networks, each of which may be trained to encode the selected first block 502A of the 3D point cloud geometry to generate an encoded first block. The selection of the coding mode may be performed in a linear manner. The starting index (j) of the selected coding (M) may be set to 0 and the index may be incremented in further iterations. It should be noted that the selected coding mode should not be considered as a final coding mode to be used in an encoding operation for the first block 502A. At 508, the selected coding mode (M₀) should merely be considered as a candidate coding mode for the selected first block 502A.

At 508, a loss computation operation may be executed for the selected first block 502A. The circuitry 202 may compute a loss value for the selected first block 502A based on the selected coding mode (such as M₀). The loss value may be associated with a compression metric such as a rate metric or an MSE metric. In accordance with an embodiment, the circuitry 202 may input the selected first block 502A to a classifier model. In such a case, the loss value may be computed based on an output of the classifier model for the input. The classifier model may be, for example, a Deep Neural Network (DNN) model trained on implicit or explicit geometric characteristics of test blocks of at least one point cloud. Such characteristics may include, for example, a density of points associated with a point cloud.

At 510, the computed loss value for the selected first block 502A may be compared with a loss threshold for the selected coding mode. During the comparison, it may be determined whether the computed loss for the selected first block 502A is less than the threshold value for the selected mode. In case the computed loss for the selected first block 502A is less than the threshold value for the selected mode, the control may pass to 512. In case the computed loss for the selected first block 502A is more than the threshold value for the selected mode, then the control may pass to 514.

In accordance with an embodiment, the loss threshold may be a different value for each coding mode of the set of RD operation points. For example, the circuitry 202 may be configured to acquire a calibration point cloud from the computing device 110 and/or the server 106. For a block of the calibration point cloud, the circuitry 202 may compute a first quartile of loss value corresponding each mode of an RD operation point of the set of RD operation points. The circuitry 202 may set the first quartile of loss value as the loss threshold corresponding to the coding mode. An example of loss thresholds for different RD operation points is given in Table 2, as follows:

TABLE 2
Loss Thresholds for RD points

| Rate Distortion Points | RD₀ | RD₁ | RD₂ | RD₃ | RD₄ |
|---|---|---|---|---|---|
| Loss Threshold | 0.800 | 0.394 | 0.267 | 0.219 | 0.161 |

In Table 2, various cost/loss threshold values of RDi operation points are shown with ‘i’ from 0 to 4. Among the RD operation points, RD₄ is associated with a minimum loss threshold of 0.161 and RD₀ is associated with a maximum loss threshold of 0.800.

In accordance with an embodiment, the circuitry 202 may set the loss threshold for the coding mode based on a user input. The user input may be provided to adjust the loss thresholds for a particular RD operation point. For example, the user input may require the loss threshold for RD₂ to change from 0.267 to 0.134. An example of the adjustment in the loss thresholds is given in Table 3, as follows:

TABLE 3
Loss Thresholds for RD points

| Rate Distortion Points | RD₀ | RD₁ | RD₂ | RD₃ | RD₄ |
|---|---|---|---|---|---|
| Loss Threshold | 0.400 | 0.197 | 0.134 | 0.110 | 0.080 |

In Table 3, various cost/loss threshold values of RDi operation points are shown with ‘i’ from 0 to 4. Among the RD operation points, RD₄ is associated with a minimum loss threshold of 0.080 and RD₁ is associated with a maximum loss threshold of 0.400.

In accordance with an embodiment, the loss threshold may be a fixed value for each coding mode that corresponds to the set of RD operation points. An example of fixed loss thresholds is provided in Table 4, as follows:

TABLE 4
Fixed Loss Thresholds for Coding Modes

| Rate Distortion Points | RD₀ | RD₁ | RD₂ | RD₃ | RD₄ |
|---|---|---|---|---|---|
| Loss Threshold | 0.800 | 0.800 | 0.800 | 0.800 | 0.800 |
| Loss Threshold | 0.394 | 0.394 | 0.394 | 0.394 | 0.394 |
| Loss Threshold | 0.267 | 0.267 | 0.267 | 0.267 | 0.267 |
| Loss Threshold | 0.219 | 0.219 | 0.219 | 0.219 | 0.219 |
| Loss Threshold | 0.161 | 0.161 | 0.161 | 0.161 | 0.161 |

At 512, an encoding operation may be performed. As part of the operation, the circuitry 202 may encode the selected first block 502A based on the selected coding mode. In accordance with an embodiment, the selected coding mode may correspond to a first deep neural network (for example, the DNN model-1 306A) and the selected first block 502A may be encoded based on application of the first deep neural network on the selected first block 502A. After 512, control may proceed to 524.

At 514, an operation may be performed to determine whether other modes are available for the selected RD operation point (e.g., RD₀). If other modes are available for the selected RD operation point (i.e., the selected mode (Mj) is not the last mode for the RD operation point), then the control may pass to 516. If other modes are not available for the selected RD operation point (i.e., the selected mode (Mj) is the last mode for the RD operation point), then the control may pass to 518.

At 516, an operation may be performed to switch to a next mode (e.g., M₁) associated the selected RD operation point (e.g., RD₀). The switch may be performed by increasing the value of model index (j) by one. After the switch, the next mode (e.g., M₁) may be selected and operations from 506 to 510 may be performed iteratively for the next mode until the loss values crosses the loss threshold for the next mode.

After iterating through all modes of the RD operation point(s), a set of loss values may be obtained for the selected first block 502A. The circuitry 202 may compute, for the selected first block 502A, a first set of loss values that may be associated with one or more compression metrics. The first set of loss values may correspond to a set of coding modes associated with a subset of the set of RDᵢ operation points. For example, from RD₀ to RD₂ (i.e., a subset of five RD operation points), there may be twelve modes (four modes per RD point) and the first set of loss values may include twelve loss values. The first set of loss values include one or more first loss values that may be computed for one or more coding modes corresponding to the first RD operation point (e.g., RD₀) of the set of RD operation points. The number of loss computations for a selected block may vary and may depend on values of the loss thresholds that may be set for the modes.

At 518, an operation may be performed to determine whether other RDi operation points are available for selection from the set of RD operation points. If other RDi operation points are available for the selection, then the control may pass to 520. If other RDi operation points are not available for the selection (i.e., the RD operation point selected at 504 is the last RD operation point in the set of RD operation points), then the control may pass to 522.

At 520, an operation may be performed to switch to a next RD operation point (e.g., RD₁) in the set of RD operation points (e.g., RD₀ . . . RD₄). The switch may be performed by increasing the value of RD index (i) by one. After the switch, the next RD operation point (e.g., RD₁) may be selected at 504 and operations from 506 to 510 may be performed iteratively for the next mode until the loss values crosses the loss threshold for the next mode. For example, the circuitry 202 may switch to a second RD operation point (RD₁) of the set of RD operation points, based on a determination that the one or more first loss values are more than one or more loss thresholds for the one or more coding modes (i.e., modes such as M0 to M₄ of RD₀) that correspond to the first RD operation point (such as RD₀). The first set of loss values (as described in 516) may include one or more second loss values that may be computed for one or more coding modes corresponding to the second RD operation point (e.g., RD₁).

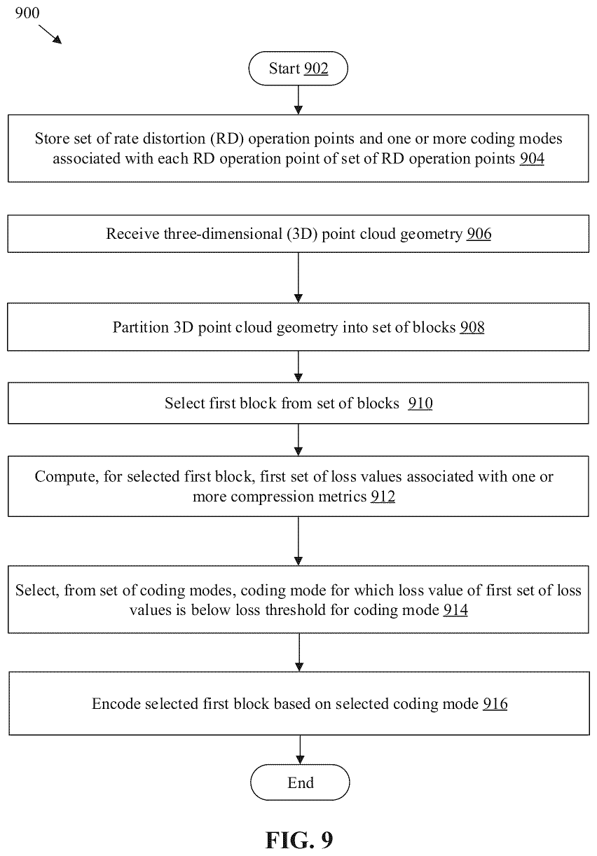

At 522, a lossless encoding operation may be performed. As part of the operation, a raw block encoding mode (LLmode) may be turned on to deal with cases where none of the RD operation points (selected at 504) to meet a local quality criteria for encoding of the selected first block 502A (i.e., loss values for all RD operation points are above the loss thresholds) and undesired artifacts (like holes) are detected in a reconstruction of the point cloud geometry during a local reconstruction at an encoding stage. The first block 502A may be stored losslessly. Specifically, the circuitry 202 may select a lossless encoding scheme for the first block 502A based on a determination that each loss value of the first set of loss values (as described in 516) is above a loss threshold for a corresponding coding mode of the set of coding modes. The circuitry 202 may encode the selected first block 502A based on the selected lossless encoding scheme. An example application of the lossless encoding scheme is provided in FIG. 9, for example.

At 524, an operation may be performed to determine whether the selected first block 502A is the last block for a selection in the set of blocks 502B. If it is determined that the selected first block 502A is the last block, then the circuitry 202 may prepare and transmit an encoded bit stream 528 associated with the point cloud geometry to the computing device 110 or the server 106. Thereafter, the control may pass to end. If it is determined that the selected first block 502A is not the last block, then the control may pass to 526.

At 526, an operation may be performed to select a next block (e.g., a second block) of the set of blocks. After the selection, operations from 504 to 524 may be repeated to process the next block and subsequent blocks until the last block of the set of blocks is processed.

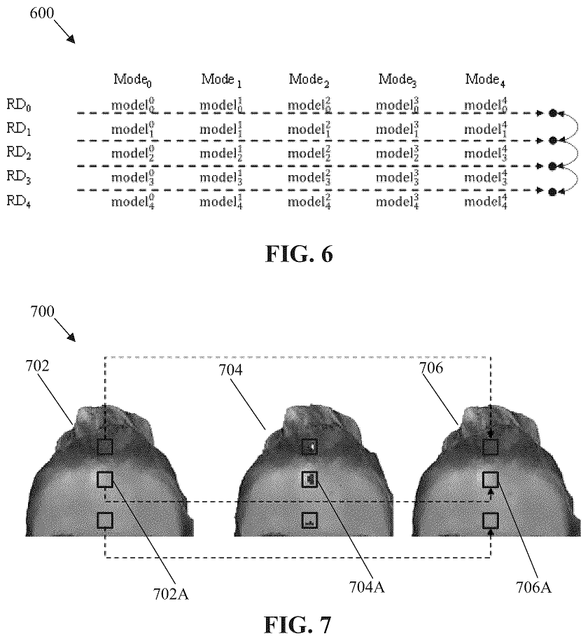

FIG. 6 is a diagram that illustrates an exemplary search pattern for modes of RD operation points, in accordance with an embodiment of the disclosure. With reference to FIG. 6, there is shown a diagram 600 of an exemplary search pattern for modes of RD operation points. FIG. 6 is described in conjunction with elements from FIG. 1, FIG. 2, FIG. 3, FIG. 4, and FIG. 5. In the diagram 600, there is shown a table of five RD operation points from RD₀ to RD₄ and five corresponding modes from mode0 to mode4. In order to search for an optimal coding mode under a particular RD operation point, a search may be executed (as described in FIG. 5). The search may initiate from RD₀, mode₀ and may proceed as a bidirectional search across all modelᵢ^{j} in RDi (as indicated by bidirectional arrows). The number of steps to find an optimal coding mode may vary and may typically depend on values of the loss thresholds that may be set for the modes.

In case none of the mode₀⁰, to mode₄⁰ for a given RD operation point (e.g., RD₀) meet a coding requirement (i.e., loss values for a block are above the loss thresholds for all modes), the circuitry 202 may switch to a next RD operation point of the set of RD operation points. For a selected block, the search may result in a pair of mode^{j}, RDᵢ for which the loss value may remain below a loss threshold for the model. The loss threshold for a given coding mode may be a static value or may be dynamically adjusted based on a human input or a target rate-distortion or quality.

FIG. 7 is a diagram that illustrates an exemplary comparison between lossy versus lossless reconstruction outputs for a point cloud geometry, in accordance with an embodiment of the disclosure. Elements of FIG. 7 are described in conjunction with elements from FIG. 1, FIG. 2, FIG. 3, FIG. 4, FIG. 5, and FIG. 6. With reference to FIG. 7, there is shown an exemplary comparison 700 between lossy versus lossless reconstruction outputs for a point cloud geometry. In the comparison 700, there is shown a point cloud geometry 702, a point cloud geometry 704, and a point cloud geometry 706. The point cloud geometry 702 represents a reference (original) point cloud of a human head. The point cloud geometry 704 may be a lossy reconstruction of encoded point cloud data that may be obtained from the point cloud geometry 702 after application of the encoder 208A on blocks of the point cloud geometry 702. For example, ML models may be configured to encode blocks of a point cloud based on RD points and optimal modes corresponding to the RD points. The selection of RD points and optimal modes is described in FIG. 5, for example. In the point cloud geometry 704, there is shown a region 704A with a hole artifact that corresponds to a region 702A of the point cloud geometry 702. The hole artifact may be caused by the lossy reconstruction. In case none of the RD points is capable to meet the local quality criteria for certain blocks (such as blocks in the region 702A) and undesired artifacts (as shown in 704A) are detected during local reconstruction at an encoding stage, a “raw block” encoding mode (LL_{mode}) may be turned on. The LL_{mode} may be used to losslessly encode the blocks in the region 702A to ensure that such undesired artifacts are not present in the local reconstruction. The point cloud geometry 706 is shown to include a region 706A reconstructed from losslessly coded blocks and correspond to the region 704A and 702A. As shown, there are no visible artifacts such as holes in the region 706A.

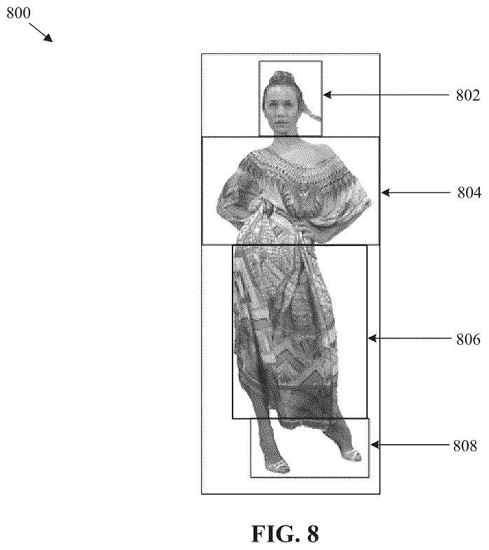

FIG. 8 is a diagram that illustrates an exemplary 3D point cloud geometry and a selection of Region of Interest (RoI) in the point cloud geometry for point cloud compression, in accordance with an embodiment of the disclosure. With reference to FIG. 10, there is shown a 3D point cloud geometry 800 that includes a portion 802, a portion 804, a portion 806, and a portion 808. Elements in FIG. 8 are described in conjunction with elements from FIG. 1, FIG. 2, FIG. 3, FIG. 4, FIG. 5, FIG. 6, and FIG. 7.

During operation, the electronic device 102 may determine a portion of the 3D point cloud geometry as a region of interest (ROI). The determination may be performed based on an input from a user (for example, a 3D artist) or an automated operation such as an object detection operation performed on the 3D point cloud geometry 800 or a semantic segmentation operation performed on the 3D point cloud geometry 800. For example, the user may explicitly define RoIs through different slices that separate the 3D point cloud geometry 800 into the portion 802, the portion 804, the portion 806, and the portion 808. The user may further assign a mode or an RD point for the respective portions such as a lossless mode (LL_{mode}) for the portion 802, RD4 for the portion 804, RD0 for the portion 806, and RD3 for the portion 808. The electronic device 102 may encode blocks corresponding to the portion 802 of the 3D point cloud geometry 800 based on a lossless encoding scheme. Blocks corresponding to other portions (such as the portion 804, the portion 806, and the portion 808) of the 3D point cloud geometry 800 may be encoded with optimal modes associated with the assigned RD points. Such modes may be identified using the operations described in FIG. 5, for example.

FIG. 9 is a flowchart that illustrates exemplary operations for a variable rate compression of a point cloud geometry, in accordance with an embodiment of the disclosure. With reference to FIG. 11, there is shown a flowchart 900. The flowchart 900 is described in conjunction with elements from FIG. 1, FIG. 2, FIG. 3, FIG. 4, FIG. 5, FIG. 6, FIG. 7, and FIG. 8. The operations 902 to 916 may be implemented on the electronic device 102. The method described in the flowchart 900 may start at 902 and proceed to 904.

At 904, a set of RD operation points and one or more coding modes associated with each RD operation point of the set of RD operation points may be stored. The electronic device 102 may include the memory 210 that may be configured to store the set of RD operation points and one or more coding modes associated with each RD operation point of the set of RD operation points.

At 906, a 3D point cloud geometry (e.g., the 3D point cloud geometry 114) may be received. In an embodiment, the circuitry 202 may be configured to receive the 3D point cloud geometry 114. The 3D point cloud geometry 114 may be received from the scanning setup 104 or the server 106 via the communication network 112. The reception of the 3D point cloud geometry is described further, for example, in FIG. 4.

At 908, the 3D point cloud geometry 114 may be partitioned into a set of blocks (e.g., the block stream 412). In an embodiment, the circuitry 202 may be configured to partition the 3D point cloud geometry 114 into the set of blocks. The partitioning of the 3D point cloud geometry is described further, for example, in FIG. 4.

At 910, a first block 502A may be selected from the set of blocks 502B. In an embodiment, the circuitry 202 may be configured to select the first block 502A from the set of blocks 502B.

At 912, a first set of loss values associated with one or more compression metrics may be computed for the selected first block 502A. The first set of loss values may correspond to a set of coding modes associated with at least a subset of the set of RD operation points. In an embodiment, the circuitry 202 may be configured to compute the first set of loss values for the selected first block 502A. The computation of the loss values is described further, for example, in FIGS. 1 and 5.

At 914, a coding mode, for which a loss value of the first set of loss values is below a loss threshold, may be selected for the selected first block 502A from the set of coding modes. In an embodiment, the circuitry 202 may be configured to select the coding mode from the set of coding modes.

At 916, the first block 502A may be encoded based on the selected coding mode. In an embodiment, the circuitry 202 may be configured to encode the first block 502A based on the selected coding mode. The encoding of the first block 502A is described further, for example, in FIG. 5. Control may pass to end.

Various embodiments of the disclosure may provide a non-transitory computer-readable medium and/or storage medium having stored thereon, computer-executable instructions executable by a machine and/or a computer to operate an electronic device (for example, the electronic device 102 of FIG. 1). Such instructions may cause the electronic device 102 to perform operations that may include storing a set of RD operation points and one or more coding modes associated with each RD operation point of the set of RD operation points. The operations may further include receiving a 3D point cloud geometry pertaining to one or more objects in 3D space and partitioning the 3D point cloud geometry into a set of blocks. The operations may further include selecting a first block from the set of blocks and computing a first set of loss values associated with one or more compression metrics for the selected first block. The set of loss values may correspond to a set of coding modes associated with at least a subset of the set of RD operation points. The operations may further include selecting, from the set of coding modes, a coding mode for which a loss value of the first set of loss values is below a loss threshold for the coding mode and encoding the selected first block based on the selected coding mode.

Exemplary aspects of the disclosure provide an electronic device (such as the electronic device 102) that may include a memory (such as the memory 210) that may be configured to store a set of RD operation points and one or more coding modes associated with each RD operation point of the set of RD operation points. The electronic device may further include circuitry (such as the circuitry 202) that may be configured to receive a 3D point cloud geometry pertaining to one or more objects in 3D space. The circuitry 202 may be further configured to partition the 3D point cloud geometry into a set of blocks and select a first block from the set of blocks. For the selected first block, the circuitry 202 may be configured to compute a first set of loss values associated with one or more compression metrics. The set of loss values may correspond to a set of coding modes associated with at least a subset of the set of RD operation points. The circuitry 202 may be further configured to select, from the set of coding modes, a coding mode for which a loss value of the first set of loss values is below a loss threshold for the coding mode. Thereafter, the circuitry 202 may encode the selected first block based on the selected coding mode.

In accordance with an embodiment, the one or more compression metrics may include a rate metric or a mean square error (MSE) metric.

In accordance with an embodiment, the circuitry 202 may be further configured to input the selected first block to a classifier model. The first set of loss values may be computed further based on an output of the classifier model for the input. The classifier model may be a Deep Neural Network (DNN) model trained on one or more geometric characteristics of test blocks of a point cloud. Such characteristics may include a density of points associated with the point cloud.

In accordance with an embodiment, the circuitry 202 may be further configured to determine a portion of the 3D point cloud geometry as a region of interest (ROI) and encode blocks corresponding to the determined portion of the 3D point cloud geometry based on a lossless encoding scheme. The portion of the 3D point cloud geometry may be determined as the ROI based on at least one of a user input, an object detection operation, or a semantic segmentation operation.

In accordance with an embodiment, each RD operation point of the set of RD operation points may be associated with one or more loss thresholds corresponding to the one or more coding modes.

In accordance with an embodiment, the coding modes may correspond to deep neural networks, each of which may be trained to encode the selected first block of the 3D point cloud geometry to generate an encoded first block. The selected first block may be encoded based on an application of a first deep neural network of the Deep Neural Networks on the selected first block. The first deep neural network may correspond to the selected coding mode.

In accordance with an embodiment, the first set of loss values may include one or more first loss values that may be computed for the one or more coding modes corresponding to a first RD operation point of the set of RD operation points. The circuitry 202 may be further configured to switch to a second RD operation point of the set of RD operation points based on a determination that the one or more first loss values are more than one or more loss thresholds for the one or more coding modes that correspond to the first RD operation point. The first set of loss values may include one or more second loss values that may be computed for one or more coding modes corresponding to the second RD operation point.

In accordance with an embodiment, the circuitry 202 may be further configured to acquire a calibration point cloud and compute for a block of the calibration point cloud, a first quartile of loss value corresponding each mode of an RD operation point of the set of RD operation points. The first quartile of loss value that corresponds to the coding mode may be set as the loss threshold.

In accordance with an embodiment, the loss threshold may be a fixed value for each coding mode that corresponds to the set of RD operation points.

In accordance with an embodiment, the circuitry 202 may be further configured to set the loss threshold for the coding mode based on a user input.

In accordance with an embodiment, the circuitry 202 may be further configured to select a lossless encoding scheme for first block based on a determination that each loss value of the first set of loss values is above a loss threshold for a corresponding coding mode of the set of coding modes. The circuitry 202 may encode the selected first block based on the selected lossless encoding scheme.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted to carry out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features that enable the implementation of the methods described herein, and which when loaded in a computer system is able to carry out these methods. Computer program, in the present context, means any expression, in any language, code or notation, of a set of instructions intended to cause a system with information processing capability to perform a particular function either directly, or after either or both of the following: a) conversion to another language, code or notation; b) reproduction in a different material form.

While the present disclosure is described with reference to certain embodiments, it will be understood by those skilled in the art that various changes may be made, and equivalents may be substituted without departure from the scope of the present disclosure. In addition, many modifications may be made to adapt a particular situation or material to the teachings of the present disclosure without departure from its scope. Therefore, it is intended that the present disclosure is not limited to the particular embodiment disclosed, but that the present disclosure will include all embodiments that fall within the scope of the appended claims.

What is claimed is:

1. An electronic device, comprising:
a memory configured to store a set of rate distortion (RD) operation points and one or more coding modes associated with each RD operation point of the set of RD operation points; and
circuitry configured to:
receive a three-dimensional (3D) point cloud geometry;
partition the 3D point cloud geometry into a set of blocks;
select a first block from the set of blocks;
compute, for the selected first block, a first set of loss values associated with one or more compression metrics,
wherein the first set of loss values corresponds to a set of coding modes associated with at least a subset of the set of RD operation points;
select, from the set of coding modes, a coding mode for which a loss value of the first set of loss values is below a loss threshold for the coding mode; and
encode the selected first block based on the selected coding mode.

2. The electronic device according to claim 1, wherein the one or more compression metrics include a rate metric or a mean square error (MSE) metric.

3. The electronic device according to claim 1, wherein the circuitry is further configured to input the selected first block to a classifier model, and wherein the first set of loss values is computed further based on an output of the classifier model for the input.

4. The electronic device according to claim 3, wherein the classifier model is a Deep Neural Network (DNN) model trained on one or more geometric characteristics of test blocks of a point cloud.

5. The electronic device according to claim 4, wherein the one or more geometric characteristics comprise a density of points associated with the point cloud.

6. The electronic device according to claim 1, wherein the circuitry is further configured to:
determine a portion of the 3D point cloud geometry as a region of interest (ROI); and
encode blocks corresponding to the determined portion of the 3D point cloud geometry based on a lossless encoding scheme.

7. The electronic device according to claim 6, wherein the portion of the 3D point cloud geometry is determined as the ROI based on at least one of a user input, an object detection operation, or a semantic segmentation operation.

8. The electronic device according to claim 1, wherein each RD operation point of the set of RD operation points is associated with one or more loss thresholds corresponding to the one or more coding modes.

9. The electronic device according to claim 1, wherein the coding modes correspond to deep neural networks, each of which is trained to encode the selected first block of the 3D point cloud geometry to generate an encoded first block.

10. The electronic device according to claim 9, wherein the selected first block is encoded based on an application of a first deep neural network of the Deep Neural Networks on the selected first block, and the first deep neural network corresponds to the selected coding mode.

11. The electronic device according to claim 1, wherein the first set of loss values include one or more first loss values that are computed for the one or more coding modes corresponding to a first RD operation point of the set of RD operation points.

12. The electronic device according to claim 11, wherein the circuitry is further configured to switch to a second RD operation point of the set of RD operation points, based on a determination that the one or more first loss values are more than one or more loss thresholds for the one or more coding modes that correspond to the first RD operation point, and
wherein the first set of loss values includes one or more second loss values that are computed for one or more coding modes corresponding to the second RD operation point.

13. The electronic device according to claim 1, wherein the circuitry is further configured to:
acquire a calibration point cloud; and
compute, for a block of the calibration point cloud, a first quartile of loss value corresponding each mode of an RD operation point of the set of RD operation points; and
set the first quartile of loss value corresponding to the coding mode as the loss threshold.

14. The electronic device according to claim 1, wherein the loss threshold is a fixed value for each coding mode that corresponds to the set of RD operation points.

15. The electronic device according to claim 1, wherein the circuitry is further configured to set the loss threshold for the coding mode based on a user input.

16. The electronic device according to claim 1, wherein the circuitry is further configured to:
select a lossless encoding scheme for first block based on a determination that each loss value of the first set of loss values is above a loss threshold for a corresponding coding mode of the set of coding modes; and
encode the selected first block based on the selected lossless encoding scheme.

17. A method, comprising:
in an electronic device:
storing a set of rate distortion (RD) operation points and one or more coding modes associated with each RD operation point of the set of RD operation points;
receiving a three-dimensional (3D) point cloud geometry;
partitioning the 3D point cloud geometry into a set of blocks;
selecting a first block from the set of blocks;
computing, for the selected first block, a first set of loss values associated with one or more compression metrics,
wherein the first set of loss values corresponds to a set of coding modes associated with at least a subset of the set of RD operation points;
selecting, from the set of coding modes, a coding mode for which a loss value of the first set of loss values is below a loss threshold for the coding mode; and
encoding the selected first block based on the selected coding mode.

18. The method according to claim 17, further comprising:
selecting a lossless encoding scheme for first block based on a determination that each loss value of the first set of loss values is above a loss threshold for a corresponding coding mode of the set of coding modes; and
encoding the selected first block based on the selected lossless encoding scheme.

19. A non-transitory computer-readable medium having stored thereon, computer-executable instructions that when executed by an electronic device, causes the electronic device to execute operations, the operations comprising:
storing a set of rate distortion (RD) operation points and one or more coding modes associated with each RD operation point of the set of RD operation points;
receiving a three-dimensional (3D) point cloud geometry;
partitioning the 3D point cloud geometry into a set of blocks;
selecting a first block from the set of blocks;
computing, for the selected first block, a first set of loss values associated with one or more compression metrics,
wherein the first set of loss values corresponds to a set of coding modes associated with at least a subset of the set of RD operation points;
selecting, from the set of coding modes, a coding mode for which a loss value of the first set of loss values is below a loss threshold for the coding mode; and
encoding the selected first block based on the selected coding mode.

20. The non-transitory computer-readable medium according to claim 19, wherein the operations comprise:
selecting a lossless encoding scheme for first block based on a determination that each loss value of the first set of loss values is above a loss threshold for a corresponding coding mode of the set of coding modes; and
encoding the selected first block based on the selected lossless encoding scheme.
